(19) United States
(12) Patent Application Publication
(10) Pub. No.: US 2016/0218790 A1
(43) Pub. Date: Jul. 28, 2016

(54) METHOD AND USER EQUIPMENT FOR TRANSMITTING CHANNEL QUALITY INDICATOR FEEDBACK

(71) Applicant: LG ELECTRONICS INC., Seoul (KR)

(72) Inventors: Daesung HWANG, Seoul (KR); Bonghoe KIM, Seoul (KR); Joonkui AHN, Seoul (KR); Dongyoun SEO, Seoul (KR); Yunjung YI, Seoul (KR)

(73) Assignee: LG ELECTRONICS INC., Seoul (KR)

(21) Appl. No.: 15/026,527

(22) PCT Filed: Oct. 6, 2014
(86) PCT No.: PCT/KR2014/009366

§ 371 Date: Mar. 31, 2016

Related U.S. Application Data
(60) Provisional application No. 61/897,222, filed on Oct. 30, 2013.
(60) Provisional application No. 61/927,954, filed on Jan. 15, 2014.

(51) Int. Cl. H04B 7/06; H04W 72/04; H04L 27/34

(52) U.S. Cl. CPC H04B 7/0632; H04L 27/34; H04W 72/0413

(57) ABSTRACT

According to one disclosure of the present specification, a method for transmitting a channel quality indicator (CQI) feedback is provided. The method comprises the steps of: receiving allocation information for a first uplink resource and allocation information for a second uplink resource; and selecting the type of a CQI table to be used for CQI feedback, wherein the type of the CQI table may comprise a first type of CQI table not including 256 quadrature amplitude modulation (QAM), and a second type of CQI table including the 256 QAM. The method comprises the steps of: selecting from the first and the second uplink resources according to the type of the CQI table which has been selected; and transmitting the CQI feedback based on the selected CQI table from the selected uplink resource in an uplink subframe.

### BACKGROUND OF THE INVENTION

1. Field of the Invention

The present invention relates to a method and user equipment for a channel quality indicator feedback in mobile communications.

2. Related Art

3GPP (3rd Generation Partnership Project) LTE (Long Term Evolution) that is an advancement of UMTS (Universal Mobile Telecommunication System) is being introduced with 3GPP release 8. In 3GPP LTE, OFDMA (orthogonal frequency division multiple access) is used for downlink, and SC-FDMA (single carrier-frequency division multiple access) is used for uplink. The 3GPP LTE adopts MIMO (multiple input multiple output) having maximum four antennas. Recently, a discussion of 3GPP LTE-A (LTE-Advanced) which is the evolution of the 3GPP LTE is in progress.

As set forth in 3GPP TS 36.211 V10.4.0, the physical channels in 3GPP LTE may be classified into data channels such as PDSCH (physical downlink shared channel) and PUSCH (physical uplink shared channel) and control channels such as PDCCH (physical downlink control channel), PCFICH (physical control format indicator channel), PHICH (physical hybrid-ARQ indicator channel) and PUCCH (physical uplink control channel).

An uplink channel is used for transmitting various uplink control information such as hybrid automatic repeat request (HARQ) ACK/NACK, channel state information (CSI) and scheduling request (SR).

Meanwhile, in a next generation mobile communication system, a higher order modulation scheme, for example, 256 quadrature amplitude modulation (QAM) can be used.

However, in the conventional system, a CSI report or other procedures are designed in accordance with maximum 64 QAM.

Accordingly, in order to introduce a new modulation scheme such as 256 QAM in a next generation mobile communication system, it is required to improve procedures in relation to the CSI report and the related procedures.

### SUMMARY OF THE INVENTION

Accordingly, a disclosure of the specification has been made in an effort to solve the aforementioned problem.

In order to achieve the aforementioned purpose, one disclosure of the present specification provides

In order to achieve the aforementioned purpose, one disclosure of the present specification provides a method for transmitting a channel quality indicator (CQI) feedback. The method may comprise: receiving allocation information on a first uplink resource and allocation information on a second uplink resource; selecting a type of CQI table which is to be used for the CQI feedback, wherein the CQI table includes a first type CQI table that does not includes 256 quadrature amplitude modulation (QAM) and a second type CQI table that includes 256 QAM; selecting one of the first and second uplink resources according to the selected CQI table; and transmitting the CQI feedback based on the selected CQI table in the selected uplink resource on an uplink subframe.

The first uplink resource may be used when the CQI feedback is performed based on the first type CQI table that does not include the 256 QAM. The second uplink resource may be used when the CQI feedback is performed based on the second type CQI table that includes the 256 QAM.

The CQI feedback may be transmitted on a physical uplink control channel (PUCCH).

The CQI feedback may be transmitted using PUCCH format 2a or 2b, if a normal cyclic prefix (CP) is applied to the uplink subframe. The CQI feedback may be transmitted using PUCCH format 2, if an extended CP is applied to the uplink subframe.

The second type CQI table may further include a field according to 256 QAM in addition to a field according to the first type CQI table.

The CQI feedback based on the second type CQI table may include a CQI table of 4-bit length, and 1 bit that divides the second type CQI table.

### Advantageous Effects

According to a disclosure of the present specification, the aforementioned problem of the conventional technique can be solved.

### BRIEF DESCRIPTION OF THE DRAWINGS

FIG. 1 illustrates a wireless communication system.

FIG. 2 illustrates the architecture of a radio frame according to frequency division duplex (FDD) of 3rd generation partnership project (3GPP) long term evolution (LTE).

FIG. 3 illustrates the architecture of a downlink radio frame according to time division duplex (TDD) in 3GPP LTE.

FIG. 4 illustrates an example resource grid for one uplink or downlink slot in 3GPP LTE.

FIG. 5 illustrates the architecture of a downlink subframe.

FIG. 6 illustrates the architecture of an uplink subframe in 3GPP LTE.

FIG. 7a illustrates an example of a periodic CSI report in 3GPP LTE.

FIG. 7b illustrates an example of an aperiodic CSI report in 3GPP LTE.

FIG. 7c illustrates an example of the simultaneous transmission of a PUCCH and a PUSCH.

FIG. 8 illustrates a PUCCH and a PUSCH on a UL subframe.

FIG. 9 illustrates a procedure of signal processing for transmitting PUCCH/PUSCH in LTE.

FIG. 10 illustrates a channel structure of a PUCCH format 2/2a/2b for one slot in a normal CP.

FIG. 11 illustrates a PUCCH format 1a/1b for one slot in the normal CP.

FIG. 12 illustrates an example of constellation mapping of ACK/NACK in a normal CP.

FIG. 13 illustrates an example of joint coding between ACK/NACK and CQI in an extended CP.

FIG. 14 illustrates a method of multiplexing ACK/NACK and SR.

FIG. 15 illustrates constellation mapping when ACK/NACK and SR are simultaneously transmitted.

FIG. 16 is a diagram illustrating a hetero network environment in which a macro cell and a small cell are mixed, which has a possibility of becoming a next generation wireless communication system.

FIG. 17 is an exemplary diagram illustrating a method according to a disclosure.

FIG. 18 is a block diagram illustrating a wireless communication system in which a disclosure of the present specification is implemented.

### DESCRIPTION OF EXEMPLARY EMBODIMENTS

Hereinafter, based on 3rd Generation Partnership Project (3GPP) long term evolution (LTE) or 3GPP LTE-advanced (LTE-A), the present invention will be applied. This is just an example, and the present invention may be applied to various wireless communication systems. Hereinafter, LTE includes LTE and/or LTE-A.

The technical terms used herein are used to merely describe specific embodiments and should not be construed as limiting the present invention. Further, the technical terms used herein should be, unless defined otherwise, interpreted as having meanings generally understood by those skilled in the art but not too broadly or too narrowly. Further, the technical terms used herein, which are determined not to exactly represent the spirit of the invention, should be replaced by or understood by such technical terms as being able to be exactly understood by those skilled in the art. Further, the general terms used herein should be interpreted in the context as defined in the dictionary, but not in an excessively narrowed manner.

The expression of the singular number in the present invention includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the present invention, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present invention.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present invention will be described in greater detail with reference to the accompanying drawings. In describing the present invention, for ease of understanding, the same reference numerals are used to denote the same components throughout the drawings, and repetitive description on the same components will be omitted. Detailed description on well-known arts which are determined to make the gist of the invention unclear will be omitted. The accompanying drawings are provided to merely make the spirit of the invention readily understood, but not should be intended to be limiting of the invention. It should be understood that the spirit of the invention may be expanded to its modifications, replacements or equivalents in addition to what is shown in the drawings.

As used herein, ‘base station’ generally refers to a fixed station that communicates with a wireless device and may be denoted by other terms such as eNB (evolved-NodeB), BTS (base transceiver system), or access point.

As used herein, ‘user equipment (UE)’ may be stationary or mobile, and may be denoted by other terms such as device, wireless device, terminal, MS (mobile station), UT (user terminal), SS (subscriber station), MT (mobile terminal) and etc.

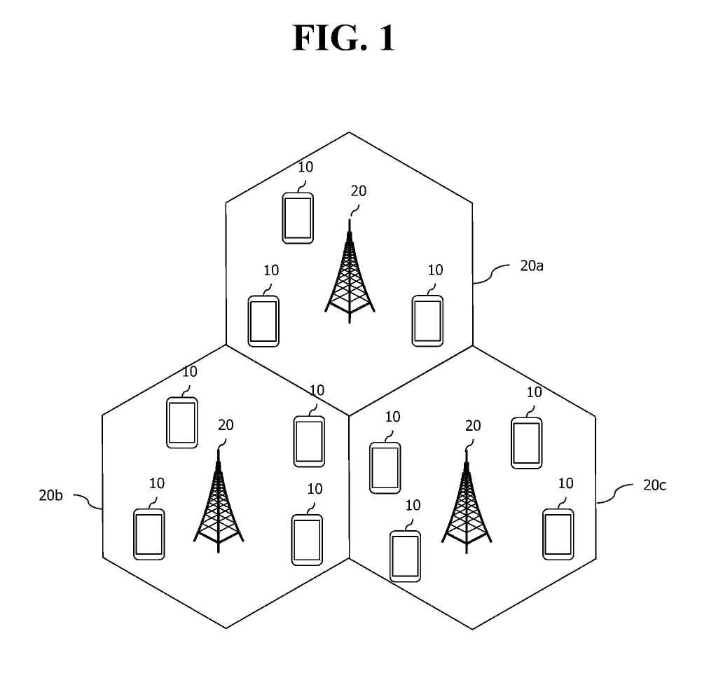

FIG. 1 shows a wireless communication system.

Referring to FIG. 1, the wireless communication system includes at least one base station (BS) 20. Respective BSs 20 provide a communication service to particular geographical areas 20a, 20b, and 20c (which are generally called cells).

The UE generally belongs to one cell and the cell to which the terminal belong is referred to as a serving cell. A base station that provides the communication service to the serving cell is referred to as a serving BS. Since the wireless communication system is a cellular system, another cell that neighbors to the serving cell is present. Another cell which neighbors to the serving cell is referred to a neighbor cell. A base station that provides the communication service to the neighbor cell is referred to as a neighbor BS. The serving cell and the neighbor cell are relatively decided based on the UE.

Hereinafter, a downlink means communication from the base station 20 to the terminal 10 and an uplink means communication from the terminal 10 to the base station 20. In the downlink, a transmitter may be a part of the base station 20 and a receiver may be a part of the terminal 10. In the uplink, the transmitter may be a part of the terminal 10 and the receiver may be a part of the base station 20.

Meanwhile, the wireless communication system may be any one of a multiple-input multiple-output (MIMO) system, a multiple-input single-output (MISO) system, a single-input single-output (SISO) system, and a single-input multiple-output (SIMO) system. The MIMO system uses a plurality of transmit antennas and a plurality of receive antennas. The MISO system uses a plurality of transmit antennas and one receive antenna. The SISO system uses one transmit antenna and one receive antenna. The SIMO system uses one transmit antenna and one receive antenna. Hereinafter, the transmit antenna means a physical or logical antenna used to transmit one signal or stream and the receive antenna means a physical or logical antenna used to receive one signal or stream.

Meanwhile, the wireless communication system may be generally divided into a frequency division duplex (FDD) type and a time division duplex (TDD) type. According to the FDD type, uplink transmission and downlink transmission are achieved while occupying different frequency bands. According to the TDD type, the uplink transmission and the downlink transmission are achieved at different time while occupying the same frequency band. A channel response of the TDD type is substantially reciprocal. This means that a downlink channel response and an uplink channel response are approximately the same as each other in a given frequency area. Accordingly, in the TDD based wireless communication system, the downlink channel response may be acquired from the uplink channel response. In the TDD type, since an entire frequency band is time-divided in the uplink transmission and the downlink transmission, the downlink transmission by the base station and the uplink transmission by the terminal may not be performed simultaneously. In the TDD system in which the uplink transmission and the downlink transmission are divided by the unit of a subframe, the uplink transmission and the downlink transmission are performed in different subframes.

Hereinafter, the LTE system will be described in detail.

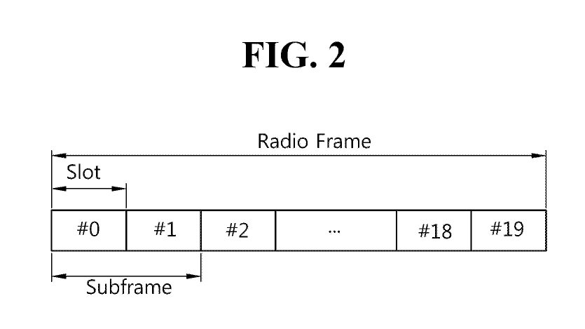

FIG. 2 shows a downlink radio frame structure according to FDD of 3rd generation partnership project (3GPP) long term evolution (LTE).

The radio frame of FIG. 2 may be found in the section 5 of 3GPP TS 36.211 V10.4.0 (2011-12) “Evolved Universal Terrestrial Radio Access (E-UTRA); Physical Channels and Modulation (Release 10)”.

Referring to FIG. 2, the radio frame consists of 10 subframes. One subframe consists of two slots. Slots included in the radio frame are numbered with slot numbers 0 to 19. A time required to transmit one subframe is defined as a transmission time interval (TTI). The TTI may be a scheduling unit for data transmission. For example, one radio frame may have a length of 10 milliseconds (ms), one subframe may have a length of 1 ms, and one slot may have a length of 0.5 ms.

The structure of the radio frame is for exemplary purposes only, and thus the number of subframes included in the radio frame or the number of slots included in the subframe may change variously.

Meanwhile, one slot may include a plurality of OFDM symbols. The number of OFDM symbols included in one slot may vary depending on a cyclic prefix (CP).

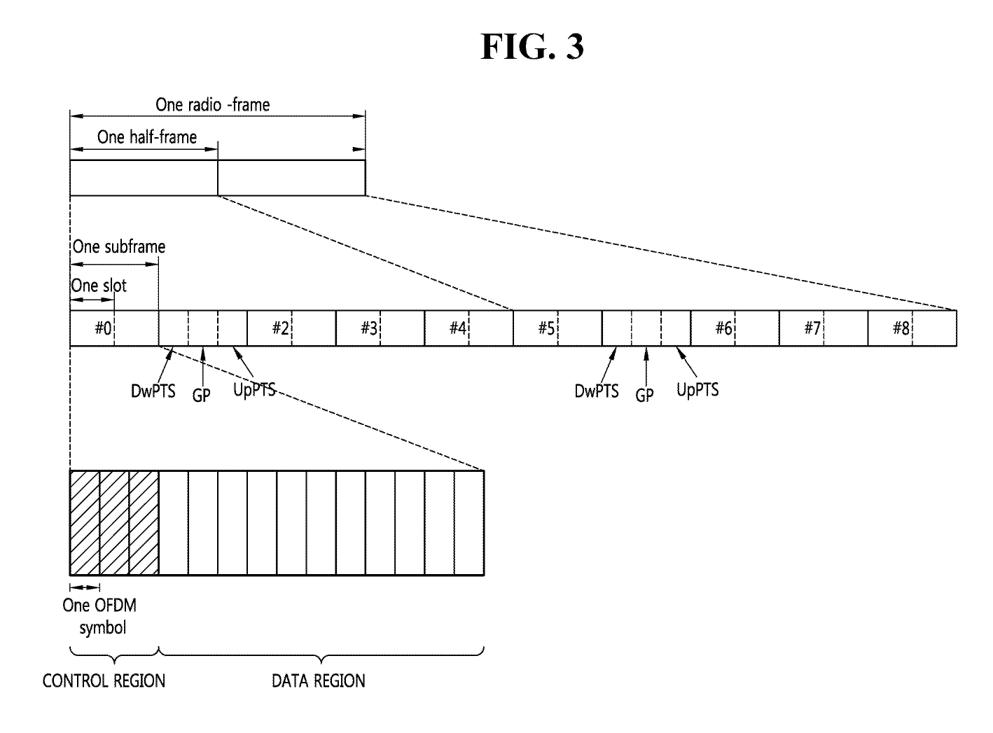

FIG. 3 shows an example of a resource grid for one uplink or downlink slot in 3GPP LTE.

For this, 3GPP TS 36.211 V10.4.0 (2011-12) “Evolved Universal Terrestrial Radio Access (E-UTRA); Physical Channels and Modulation (Release 8)”, Ch. 4 may be referenced, and this is for TDD (time division duplex).

The radio frame includes 10 sub-frames indexed 0 to 9. One sub-frame includes two consecutive slots. The time for one sub-frame to be transmitted is denoted TTI (transmission time interval). For example, the length of one sub-frame may be 1 ms, and the length of one slot may be 0.5 ms.

One slot may include a plurality of OFDM (orthogonal frequency division multiplexing) symbols in the time domain. The OFDM symbol is merely to represent one symbol period in the time domain since 3GPP LTE adopts OFDMA (orthogonal frequency division multiple access) for downlink (DL), and thus, the multiple access scheme or name is not limited thereto. For example, OFDM symbol may be denoted by other terms such as SC-FDMA (single carrier-frequency division multiple access) symbol or symbol period.

By way of example, one slot includes seven OFDM symbols. However, the number of OFDM symbols included in one slot may vary depending on the length of CP (cyclic prefix). According to 3GPP TS 36.211 V8.7.0, one slot, in the normal CP, includes seven OFDM symbols, and in the extended CP, includes six OFDM symbols.

Resource block (RB) is a resource allocation unit and includes a plurality of sub-carriers in one slot. For example, if one slot includes seven OFDM symbols in the time domain and the resource block includes 12 sub-carriers in the frequency domain, one resource block may include 7×12 resource elements (REs).

Sub-frames having index #1 and index #6 are denoted special sub-frames, and include a DwPTS (Downlink Pilot Time Slot: DwPTS), a GP (Guard Period) and an UpPTS (Uplink Pilot Time Slot). The DwPTS is used for initial cell search, synchronization, or channel estimation in a terminal. The UpPTS is used for channel estimation in the base station and for establishing uplink transmission sync of the terminal. The GP is a period for removing interference that arises on uplink due to a multi-path delay of a downlink signal between uplink and downlink.

In TDD, a DL (downlink) sub-frame and a UL (Uplink) co-exist in one radio frame. Table 1 shows an example of configuration of a radio frame.

TABLE 1

| UL-DL | Switch- | | | | | | | | | | | |
|---|---|---|---|---|---|---|---|---|---|---|---|---|
| Config- | point | | Subframe index | | | | | | | | | |
| uraiton | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

‘D’ denotes a DL sub-frame, ‘U’ a UL sub-frame, and ‘S’ a special sub-frame. When receiving a UL-DL configuration from the base station, the terminal may be aware of whether a sub-frame is a DL sub-frame or a UL sub-frame according to the configuration of the radio frame.

The DL (downlink) sub-frame is split into a control region and a data region in the time domain. The control region includes up to three first OFDM symbols in the first slot of the sub-frame. However, the number of OFDM symbols included in the control region may be changed. A PDCCH and other control channels are assigned to the control region, and a PDSCH is assigned to the data region.

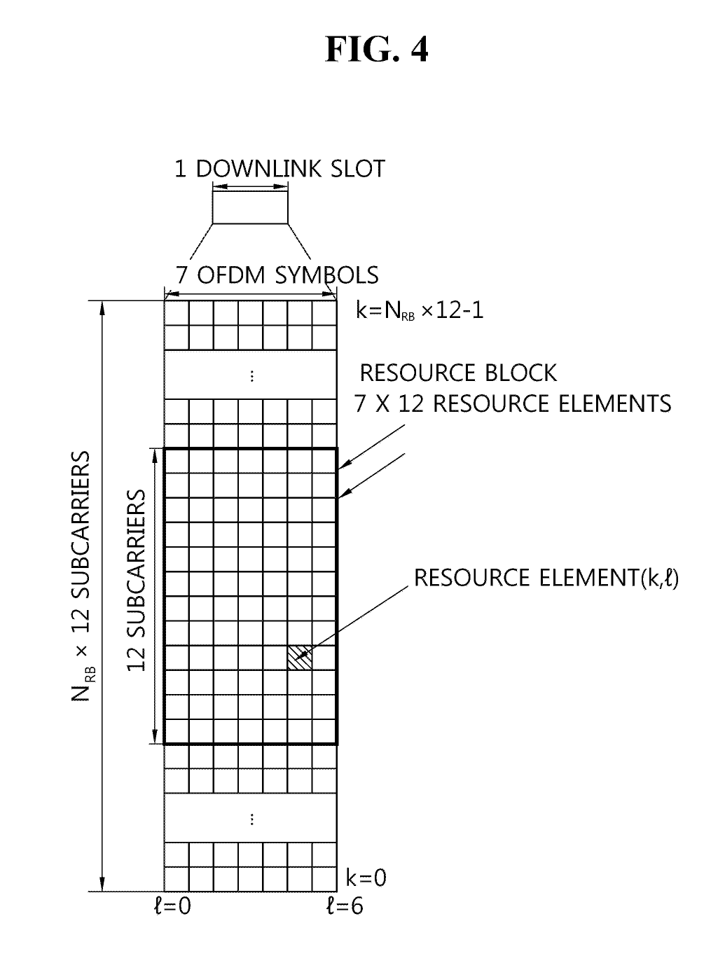

FIG. 4 illustrates an example resource grid for one uplink or downlink slot in 3GPP LTE.

Referring to FIG. 4, the uplink slot includes a plurality of OFDM (orthogonal frequency division multiplexing) symbols in the time domain and NRB resource blocks (RBs) in the frequency domain. For example, in the LTE system, the number of resource blocks (RBs), i.e., N_{RB}, may be one from 6 to 110.

Here, by way of example, one resource block includes 7×12 resource elements that consist of seven OFDM symbols in the time domain and 12 sub-carriers in the frequency domain. However, the number of sub-carriers in the resource block and the number of OFDM symbols are not limited thereto. The number of OFDM symbols in the resource block or the number of sub-carriers may be changed variously. In other words, the number of OFDM symbols may be varied depending on the above-described length of CR In particular, 3GPP LTE defines one slot as having seven OFDM symbols in the case of CP and six OFDM symbols in the case of extended CP.

OFDM symbol is to represent one symbol period, and depending on system, may also be denoted SC-FDMA symbol, OFDM symbol, or symbol period. The resource block is a unit of resource allocation and includes a plurality of sub-carriers in the frequency domain. The number of resource blocks included in the uplink slot, i.e., N_{UL}, is dependent upon an uplink transmission bandwidth set in a cell. Each element on the resource grid is denoted resource element.

Meanwhile, the number of sub-carriers in one OFDM symbol may be one of 128, 256, 512, 1024, 1536, and 2048.

In 3GPP LTE, the resource grid for one uplink slot shown in FIG. 4 may also apply to the resource grid for the downlink slot.

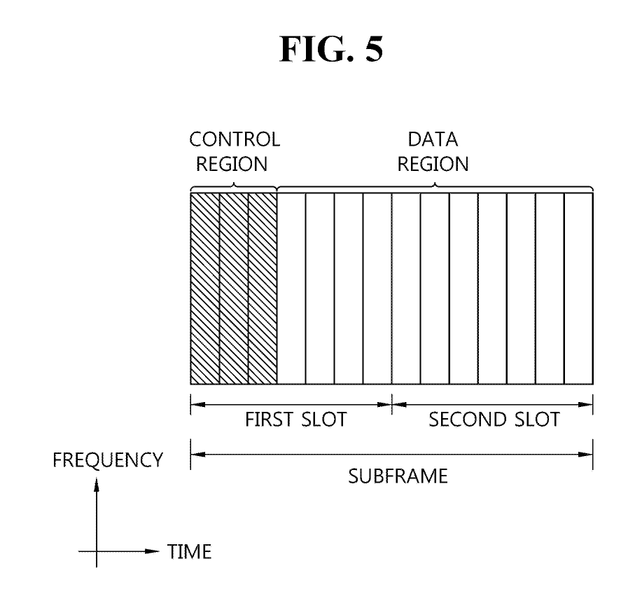

FIG. 5 illustrates the architecture of a downlink sub-frame.

In FIG. 5, assuming the normal CP, one slot includes seven OFDM symbols, by way of example. However, the number of OFDM symbols included in one slot may vary depending on the length of CP (cyclic prefix). That is, as described above, according to 3GPP TS 36.211 V10.4.0, one slot includes seven OFDM symbols in the normal CP and six OFDM symbols in the extended CP.

Resource block (RB) is a unit for resource allocation and includes a plurality of sub-carriers in one slot. For example, if one slot includes seven OFDM symbols in the time domain and the resource block includes 12 sub-carriers in the frequency domain, one resource block may include 7×12 resource elements (REs).

The DL (downlink) sub-frame is split into a control region and a data region in the time domain. The control region includes up to first three OFDM symbols in the first slot of the sub-frame. However, the number of OFDM symbols included in the control region may be changed. A PDCCH (physical downlink control channel) and other control channels are assigned to the control region, and a PDSCH is assigned to the data region.

The physical channels in 3GPP LTE may be classified into data channels such as PDSCH (physical downlink shared channel) and PUSCH (physical uplink shared channel) and control channels such as PDCCH (physical downlink control channel), PCFICH (physical control format indicator channel), PHICH (physical hybrid-ARQ indicator channel) and PUCCH (physical uplink control channel).

The PCFICH transmitted in the first OFDM symbol of the sub-frame carries CIF (control format indicator) regarding the number (i.e., size of the control region) of OFDM symbols used for transmission of control channels in the sub-frame. The wireless device first receives the CIF on the PCFICH and then monitors the PDCCH.

Unlike the PDCCH, the PCFICH is transmitted through a fixed PCFICH resource in the sub-frame without using blind decoding.

The PHICH carries an ACK (positive-acknowledgement)/NACK (negative-acknowledgement) signal for a UL HARQ (hybrid automatic repeat request). The ACK/NACK signal for UL (uplink) data on the PUSCH transmitted by the wireless device is sent on the PHICH.

The PBCH (physical broadcast channel) is transmitted in the first four OFDM symbols in the second slot of the first sub-frame of the radio frame. The PBCH carries system information necessary for the wireless device to communicate with the base station, and the system information transmitted through the PBCH is denoted MIB (master information block). In comparison, system information transmitted on the PDSCH indicated by the PDCCH is denoted SIB (system information block).

The PDCCH may carry activation of VoIP (voice over internet protocol) and a set of transmission power control commands for individual UEs in some UE group, resource allocation of an higher layer control message such as a random access response transmitted on the PDSCH, system information on DL-SCH, paging information on PCH, resource allocation information of UL-SCH (uplink shared channel), and resource allocation and transmission format of DL-SCH (downlink-shared channel). A plurality of PDCCHs may be sent in the control region, and the terminal may monitor the plurality of PDCCHs. The PDCCH is transmitted on one CCE (control channel element) or aggregation of some consecutive CCEs. The CCE is a logical allocation unit used for providing a coding rate per radio channel's state to the PDCCH. The CCE corresponds to a plurality of resource element groups. Depending on the relationship between the number of CCEs and coding rates provided by the CCEs, the format of the PDCCH and the possible number of PDCCHs are determined.

The control information transmitted through the PDCCH is denoted downlink control information (DCI). The DCI may include resource allocation of PDSCH (this is also referred to as DL (downlink) grant), resource allocation of PUSCH (this is also referred to as UL (uplink) grant), a set of transmission power control commands for individual UEs in some UE group, and/or activation of VoIP (Voice over Internet Protocol).

The base station determines a PDCCH format according to the DCI to be sent to the terminal and adds a CRC (cyclic redundancy check) to control information. The CRC is masked with a unique identifier (RNTI; radio network temporary identifier) depending on the owner or purpose of the PDCCH. In case the PDCCH is for a specific terminal, the terminal's unique identifier, such as C-RNTI (cell-RNTI), may be masked to the CRC. Or, if the PDCCH is for a paging message, a paging indicator, for example, P-RNTI (paging-RNTI) may be masked to the CRC. If the PDCCH is for a system information block (SIB), a system information identifier, SI-RNTI (system information-RNTI), may be masked to the CRC. In order to indicate a random access response that is a response to the terminal's transmission of a random access preamble, an RA-RNTI (random access-RNTI) may be masked to the CRC.

In 3GPP LTE, blind decoding is used for detecting a PDCCH. The blind decoding is a scheme of identifying whether a PDCCH is its own control channel by demasking a desired identifier to the CRC (cyclic redundancy check) of a received PDCCH (this is referred to as candidate PDCCH) and checking a CRC error. The base station determines a PDCCH format according to the DCI to be sent to the wireless device, then adds a CRC to the DCI, and masks a unique identifier (this is referred to as RNTI (radio network temporary identifier) to the CRC depending on the owner or purpose of the PDCCH.

The uplink channels include a PUSCH, a PUCCH, an SRS (Sounding Reference Signal), and a PRACH (physical random access channel).

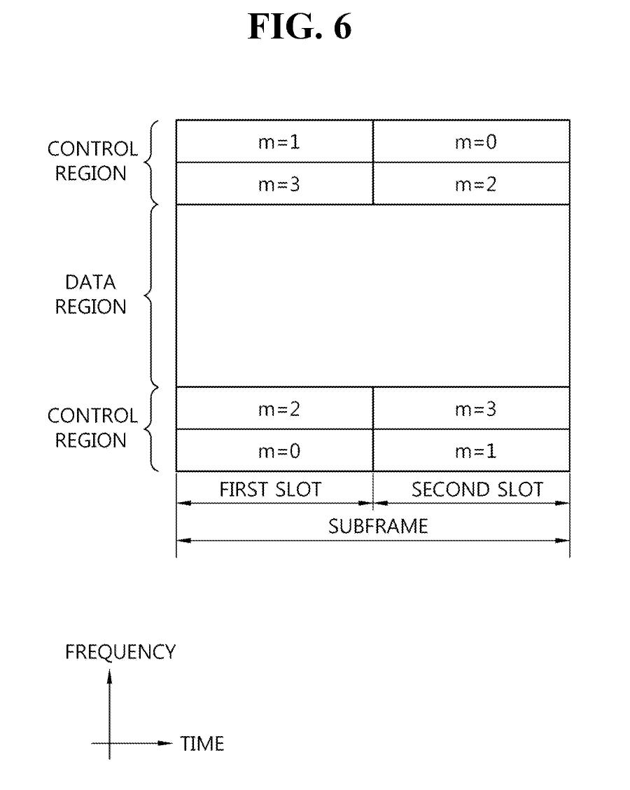

FIG. 6 shows a structure of an uplink subframe in 3GPP LTE.

Referring to FIG. 6, the uplink subframe can be divided into a control region and a data region. A physical uplink control channel (PUCCH) for carrying uplink control information is allocated to the control region. A physical uplink shared channel (PUSCH) for carrying data is allocated to the data region.

The PUCCH for one UE is allocated in an RB pair in a subframe. RBs belonging to the RB pair occupy different subcarriers in each of a first slot and a second slot. A frequency occupied by the RBs belonging to the RB pair to which the PUCCH is allocated changes at a slot boundary. This is called that the RB pair allocated to the PUCCH is frequency-hopped at the slot boundary.

Since the UE transmits the uplink control information on a time basis through different subcarriers, a frequency diversity gain can be obtained. m is a location index indicating a logical frequency domain location of a RB pair allocated to a PUCCH in a subframe.

Examples of the uplink control information transmitted on a PUCCH include hybrid automatic repeat request (HARQ), acknowledgement (ACK)/non-acknowledgement (NACK), channel quality indicator (CQI) indicating a DL channel state, scheduling request (SR) which is a UL radio resource allocation request, etc.

The PUSCH is mapped to an uplink shared channel (UL-SCH) which is a transport channel. Uplink data transmitted through the PUSCH may be a transport block which is a data block for the UL-SCH transmitted during a TTI. The transport block may be user information. In addition, the uplink data may be multiplexed data. The multiplexed data may be obtained by multiplexing the control information and a transport block for the UL-SCH.

<Carrier aggregation: CA>

A carrier aggregation system is now described.

A carrier aggregation system aggregates a plurality of component carriers (CCs). A meaning of an existing cell is changed according to the above carrier aggregation. According to the carrier aggregation, a cell may signify a combination of a downlink component carrier and an uplink component carrier or an independent downlink component carrier.

Further, the cell in the carrier aggregation may be classified into a primary cell, a secondary cell, and a serving cell. The primary cell signifies a cell operated in a primary frequency. The primary cell signifies a cell which UE performs an initial connection establishment procedure or a connection reestablishment procedure or a cell indicated as a primary cell in a handover procedure. The secondary cell signifies a cell operating in a secondary frequency. Once the RRC connection is established, the secondary cell is used to be provided an additional radio resource.

As described above, the carrier aggregation system may support a plurality of component carriers (CCs), that is, a plurality of serving cells unlike a single carrier system.

The carrier aggregation system may support a cross-carrier scheduling. The cross-carrier scheduling is a scheduling method capable of performing resource allocation of a PDSCH transmitted through other component carrier through a PDCCH transmitted through a specific component carrier and/or resource allocation of a PUSCH transmitted through other component carrier different from a component carrier basically linked with the specific component carrier.

<Transmission of Channel Status Information (CSI)>

Hereinafter, a periodic transmission and an aperiodic transmission of the channel status information (CSI) will be described.

The channel state information (CSI) is an indicator for indicating a state of a DL channel, and may include at least any one of a channel quality indicator (CQI) and a precoding matrix indicator (PMI). Further, a precoding type indicator (PTI), a rank indication (RI), etc., may be included.

The CQI provides information on a link adaptive parameter that can be supported by a UE for a given time. The CQI may be generated by using various methods. For example, there is a method of directly quantizing and feeding back a channel state, a method of calculating and feeding back an SINR, a method of reporting a state actually applied to the channel such as a modulation coding scheme (MCS). If the CQI is generated on the basis of the MCS, the MCS includes a modulation scheme, a coding scheme, and a coding rate or the like based thereon. In this case, a BS may determine a modulation that is to be applied to a DL channel, for example, m-Phase Shift Keying (m-PSK) or m-Quadrature Amplitude Modulation (m-QAM) and coding rate by using the CQI. The Table below represents modulation schemes according to the CQI index, code rates and efficiencies. The CQI index shown in the Table below may be represented by 4 bits.

TABLE 2

| CQI | Modulation | (Code rate) × | |
|---|---|---|---|
| index | scheme | 1024 | Efficiency |
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16 QAM | 378 | 1.4766 |
| 8 | 16 QAM | 490 | 1.9141 |
| 9 | 16 QAM | 616 | 2.4063 |
| 10 | 64 QAM | 466 | 2.7305 |
| 11 | 64 QAM | 567 | 3.3223 |
| 12 | 64 QAM | 666 | 3.9023 |
| 13 | 64 QAM | 772 | 4.5234 |
| 14 | 64 QAM | 873 | 5.1152 |
| 15 | 64 QAM | 948 | 5.5547 |

The PMI provides information for a precoding matrix in codebook-based precoding. The PMI is in association with multiple input multiple output (MIMO). When the PMI is fed back in MIMO, it is called closed-loop MIMO.

The RI is information for the number of layers recommended by the UE. That is, the RI indicates the number of streams used in spatial multiplexing. The RI is fed back only when it operates in a MIMO mode in which the UE uses spatial multiplexing. The RI is also in association with one or more CQI feedbacks. That is, a specific RI value is assumed in calculation of the CQI to be fed back. A rank of a channel changes slowly in general in comparison with the CQI, and thus the RI is fed back in a less number of times than the CQI. An RI transmission periodicity may be a multiple of a CQI/PMI transmission periodicity. The RI is given for a full system band, and a frequency selective RI feedback is not supported.

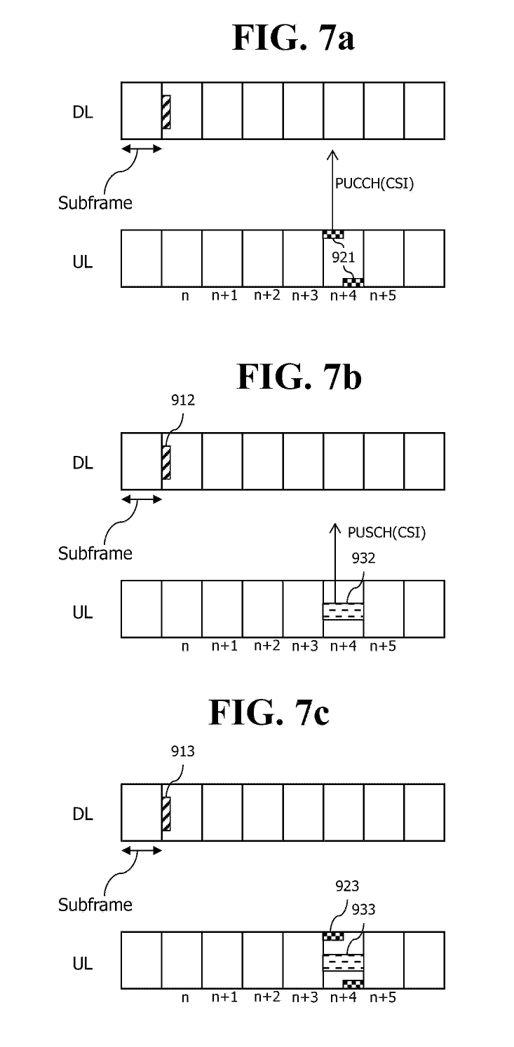

FIG. 7a illustrates an example of a periodic CSI report in 3GPP LTE.

As shown in FIG. 7a, the CSI may be transmitted through the PUCCH periodically according to a period determined in the upper layer. That is, the periodic channel status information (CSI) may be transmitted through the PUCCH.

The UE may be semi-statically configured by an upper layer signal so as to periodically feed-back a differential CSI (CQI, PMI, RI) through the PUCCH. In this case, the UE transmits the corresponding CSI according to modes defined as shown in a table given below.

TABLE 3

| | | PMI feed-back time | |
|---|---|---|---|
| | | No PMI | Single PMI |
| PUCCH CQI | Wideband CQI | Mode 1-0 | Mode 2-0 |
| feed-back type | | | |
| | Selective subband | Mode 2-0 | Mode 2-1 |
| | CQI | | |

A periodic CSI reporting mode in the PUCCH described below is supported for each of the aforementioned transmission modes.

TABLE 4

| Transmission mode | PUCCH CSI reporting mode |
|---|---|
| Transmission mode 1 | Modes 1-0, 2-0 |
| Transmission mode 2 | Modes 1-0, 2-0 |
| Transmission mode 3 | Modes 1-0, 2-0 |
| Transmission mode 4 | Modes 1-1, 2-1 |
| Transmission mode 5 | Modes 1-1, 2-1 |
| Transmission mode 6 | Modes 1-1, 2-1 |
| Transmission mode 7 | Modes 1-0, 2-0 |
| Transmission mode 8 | When PMI/RI reporting is configured to UE in |
| | modes 1-1 and 2-1; |
| | When PMI/RI reporting is not configured to UE |
| | in modes 1-0 and 2-0 |
| transmission mode 9 | When PMI/RI reporting is configured to UE in |
| | modes 1-1 and 2-1 and the number of CSI-RS |
| | ports is larger than 1. |
| | When PMI/RI reporting is not configured to UE |
| | in modes 1-0 and 2-0 or the number of CSI-RS |
| | ports is 1 |

Meanwhile, a collision of the CSI report means a case in which a subframe configured to transmit a first CSI and a subframe configured to transmit a second CSI are the same as each other. When the collision of the CSI report occurs, the first CSI and the second CSI are simultaneously transmitted, or the transmission of a CSI having a low priority is discarded (alternatively, referred to as abandon or drop), and a CSI having a high priority may be transmitted, according to priorities of the first CSI and the second CSI.

The CSI report through the PUCCH may include various report types according to a transmission combination of the CQI, the PMI, and the RI, and a period and an offset value divided according to each report type (hereinafter, abbreviated as a type) are supported.

Type 1: Supports CQI feedback for a subband selected by the UE.

Type 1a: Supports subband CQI and second PMI feedback.

Types 2, 2b, and 2c: Supports wideband CQI and PMI feedback.

Type 2a: Supports wideband PMI feedback.

Type 3: Supports RI feedback.

Type 4: Transmits the wideband CQI.

Type 5: Supports RI and wideband PMI feedback.

Type 6: Supports RI and PTI feedback.

Hereinafter, the aperiodic transmission of CSI is described.

FIG. 7b illustrates an example of an aperiodic CSI report in 3GPP LTE.

A control signal that requests the transmission of CSI, that is, an aperiodic CSI request signal, may be included in the scheduling control signal of a PUSCH transmitted in a PDCCH 912, that is, an UL grant. In this case, UE aperiodically reports CSI through a PUSCH. As described above, the transmission of CSI on a PUSCH is called an aperiodic CSI report in that it is triggered in response to a request from a BS. The CSI report may be triggered by an UL grant or a random access response grant.

More specifically, a wireless device receives an UL grant, including information about the scheduling of the PUSCH, through the PDCCH in a subframe n. The UL grant may include a CQI request field. The following table illustrates an example of a CQI request field of 2 bits. The value or number of bits of the CQI request field is only an example.

TABLE 5

| Value of CQI | |
|---|---|
| request field | Contents |
| 00 | A CSI report is not triggered |
| 01 | A CSI report on a serving cell is triggered |
| 10 | A CSI report on a first set of serving cells is triggered |
| 11 | A CSI report on a second set of serving cells is triggered |

A BS may previously notify a wireless device of information about the first and the second sets whose CSI reports are triggered.

A BS may previously notify a wireless device of information about the first and the second sets whose CSI reports are triggered.

When a CSI report is triggered, the wireless device sends CSI on the PUSCH in a subframe n+k. In this case, k=4, but is only an example.

A BS may previously designate report mode for CSI to a wireless device.

The following table illustrates an example of CSI report modes in 3GPP LTE.

TABLE 6

| | PMI feedback type | | |
|---|---|---|---|
| | No PMI | Single PMI | Multiple PMI |
| Wideband CQI | | | Mode 1-2 |
| Selective subband CQI | Mode 2-0 | | Mode 2-2 |
| Set subband CQI | Mode 3-0 | Mode 3-1 | |

(1) Mode 1-2 (Mode 1-2)

(1) Mode 1-2 (Mode 1-2)

A precoding matrix is selected on the assumption that DL data is transmitted only through a corresponding subband with respect to each subband. A wireless device generates a CQI (called a wideband CQI) by assuming the selected precoding matrix with respect to a band (called a band set S) designated by a system band or a high layer signal.

The wireless device sends CSI including the wideband CQI and the PMI of each subband. In this case, the size of each subband may be different depending on the size of a system band.

(2) Mode 2-0

A wireless device selects preferred M subbands with respect to a band (band set S) designated by a system band or a high layer signal. The wireless device generates a subband CQI by assuming that data has been transmitted in the selected M subbands. The wireless device additionally generates a single wideband CQI with respect to the system band or the band set S.

The wireless device sends CSI, including information about the selected M subbands, the subband CQI, and the wideband CQI.

(3) Mode 2-2

A wireless device selects M preferred subbands and a single precoding matrix for the M preferred subbands on the assumption that DL data is transmitted through the M preferred subbands.

Subband CSI for the M preferred subbands is defined in each codeword. In addition, the wireless device generates a wideband CQI for a system band or a band set S.

The wireless device sends CSI, including the M preferred subbands, a single subband CQI, and a PMI, wideband PMI, and wideband CQI for the M preferred subbands.

(4) Mode 3-0

A wireless device sends CSI, including a wideband CQI and a subband CQI for configured subbands.

(5) Mode 3-1

A wireless device generates a single precoding matrix for a system band or a band set S. The wireless device generates a subband CQI for each codeword by assuming the generated single precoding matrix. The wireless device may generate a wideband CQI by assuming the single precoding matrix.

The simultaneous transmission of a PUCCH and a PUSCH is described below.

In 3GPP Release 8 or Release 9 systems, UE is not allowed to simultaneously send a PUCCH and a PUSCH on a single carrier in order to maintain single carrier characteristics when using the SC-FDMA method for uplink transmission.

In 3GPP Release 10 systems, however, whether a PUCCH and a PUSCH are simultaneously transmitted may be indicated by a higher layer. That is, UE may simultaneously send a PUCCH and a PUSCH or may send only one of a PUCCH and a PUSCH in response to an instruction from a higher layer.

FIG. 7c illustrates an example of the simultaneous transmission of a PUCCH and a PUSCH.

As may be seen with reference to FIG. 7c, UE receives a PDCCH 913 in a subframe n.

Furthermore, the UE may simultaneously send a PUCCH 923 and a PUSCH 933 in a subframe n+4, for example.

The simultaneous transmission of the PUCCH and the PUSCH is defined as follows in a 3GPP Release 10 system.

It is assumed that UE has been configured for only a single serving cell and configured to not simultaneously send a PUSCH and a PUCCH. In this case, if the UE does not send a PUSCH, UCI may be transmitted according to the PUCCH formats 1/1a/1b/3. If the UE sends a PUSCH, but the PUSCH does not correspond to a random access response grant, UCI may be transmitted through the PUSCH.

Unlike in the above, it is assumed that UE has been configured for only a single serving cell and configured to not simultaneously send a PUSCH and a PUCCH. In this case, if UCI includes only HARQ-ACK and an SR, UCI may be transmitted through a PUCCH according to the PUCCH formats 1/1a/1b/3. If UCI includes only periodic CSI, however, the UCI may be transmitted on a PUCCH according to the PUCCH format 2. Alternatively, if UCI includes periodic CSI and HARQ-ACK and the UE does not send a PUSCH, the UCI may be transmitted through a PUCCH according to the PUCCH formats 2/2a/2b. Alternatively, if UCI includes only HARQ-ACK/NACK or UCI includes HARQ-ACK/NACK and an SR, UCI includes an affirmative SR and periodic/aperiodic CSI, or UCI includes only aperiodic CSI, the HARQ-ACK/NACK, the SR, and the affirmative SR may be transmitted through a PUCCH, and the periodic/aperiodic CSI may be transmitted through a PUSCH.

Unlike in the above, it is assumed that UE has been configured for one or more serving cells and configured to not simultaneously send a PUSCH and a PUCCH. In this case, if the UE does not send a PUSCH, UCI may be transmitted through a PUCCH according to the PUCCH formats 1/1a/1b/3. If UCI includes aperiodic CSI or includes aperiodic UCI and HARQ-ACK, the UCI may be transmitted through the PUSCH of a serving cell. Alternatively, if UCI includes periodic CSI and HARQ-ACK/NACK and the UE does not send a PUSCH in the subframe n of a primary cell, the UCI may be transmitted through the PUSCH.

Unlike in the above, it is assumed that UE has been configured for one or more serving cells and configured to be able to simultaneously send a PUSCH and a PUCCH. In this case, if UCI includes one or more of HARQ-ACK and an SR, the UCI may be transmitted through a PUCCH according to the PUCCH formats 1/1a/1b/3. If UCI includes only periodic CSI, however, the UCI may be transmitted through a PUCCH using the PUCCH format 2. Alternatively, if UCI includes periodic CSI and HARQ-ACK/NACK and the UE does not send a PUSCH, CSI may be dropped (or abandoned) without being transmitted according to some conditions. Alternatively, if UCI is transmitted through HARQ-ACK/NACK and periodic CSI and the UE sends a PUSCH in the subframe of a primary cell, the HARQ-ACK/NACK may be transmitted through a PUCCH according to the PUCCH formats 1a/1b/3 and the periodic CSI may be transmitted through the PUSCH.

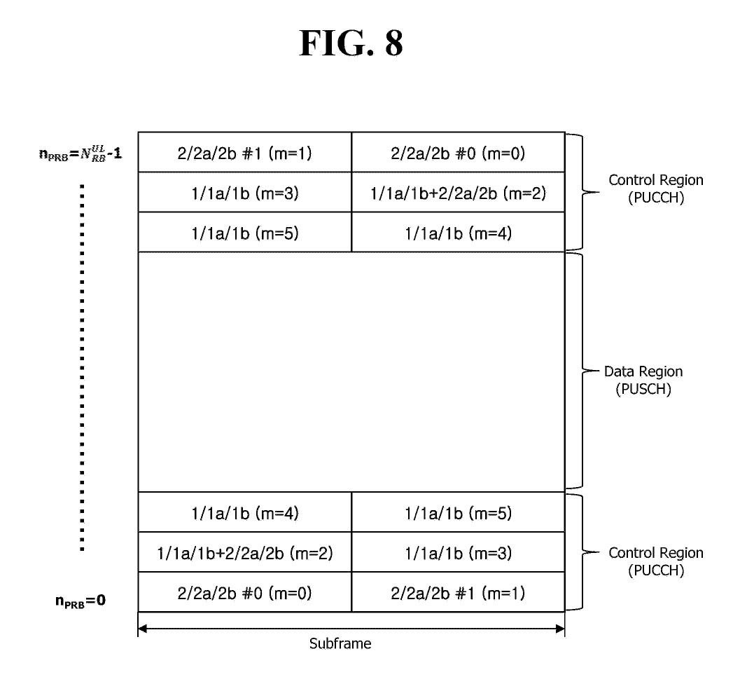

FIG. 8 illustrates a PUCCH and a PUSCH on a UL subframe.

PUCCH formats will be described with reference to FIG. 8.

Uplink control information (UCI) may be transmitted on the PUCCH. In this case, the PUCCH carries various types of control information according to a format. The UCI includes a HARQ ACK/NACK, a scheduling request (SR), and channel status information (CSI) representing a DL channel status.

PUCCH format 1 carries a scheduling request (SR). In this case, an on-off keying (OOK) scheme may be applied. PUCCH format 1a carries an acknowledgement/non-acknowledgment (ACK/NACK) modulated by a binary phase shift keying (BPSK) scheme with respect to one codeword. PUCCH format 1b carries an ACK/NACK modulated by a quadrature phase shift keying (QPSK) scheme with respect to two codewords. PUCCH format 2 carries a channel quality indicator (CQI) modulated by the QPSK scheme. PUCCH formats 2a and 2b carry the CQI and the ACK/NACK.

Table 7 below illustrates PUCCH formats.

TABLE 7

| | | Total bit | |
|---|---|---|---|
| | Modulation | number per | |
| Format | scheme | subframe | Description |
| Format 1 | Undecided | Undecided | Scheduling request (SR) |
| Format 1a | BPSK | 1 | ACK/NACK of 1 bit HARQ, |
| | | | Scheduling request (SR) may |
| | | | exist or not |
| Format 1b | QPSK | 2 | ACK/NACK of 2 bit HARQ, |
| | | | Scheduling request (SR) may |
| | | | exist or not |
| Format 2 | QPSK | 20 | In the case of extended CP, |
| | | | CSI and HARQ ACK/NACK |
| | | | of 1 bit or 2 bits |
| Format 2a | QPSK + BPSK | 21 | CSI and HARQ ACK/NACK |
| | | | of 1 bit |
| Format 2b | QPSK + BPSK | 22 | CSI and HARQ ACK/NACK |
| | | | of 2 bits |
| Format 3 | QPSK | 48 | A plurality of ACK/NACKs |
| | | | for carrier aggregation |

Each PUCCH format is mapped in the PUCCH to be transmitted. For example, the PUCCH formats 2/2a/2b are mapped in the resource block (m=0, 1 in FIG. 7) of a band edge allocated to the UE to be transmitted. A mixed PUCCH resource block (RB) may be mapped in a resource block (for example, m=2) adjacent to the resource block to which the PUCCH formats 2/2a/2b are allocated in a central direction of the band to be transmitted. The PUCCH formats 1/1a/1b to which the SR and the ACK/NACK are transmitted may be disposed in a resource block of m=4 or m=5. The number N(2)RB of resource blocks which may be used in the PUCCH formats 2/2a/2b to which the CQI is transmitted may be indicated to the UE through a broadcasted signal.

Meanwhile, the illustrated PUSCH is mapped to an uplink shared channel (UL-SCH) which is a transmission channel. The UL data transmitted on the PUSCH may be a transmission block which is a data block for the UL-SCH transmitted during the TTI. The transmission block may include user data. Alternatively, the uplink data may be multiplexed data. The multiplexed data may be acquired by multiplexing the transmission block for the UL-SCH and the channel status information. For example, the channel status information (CSI) multiplexed in the data may include the CQI, the PMI, the RI, and the like. Alternatively, the uplink data may be constituted by only the uplink status information. Periodic or aperiodic channel status information may be transmitted through the PUSCH.

The PUSCH is allocated by the UL grant on the PDCCH. Although not illustrated, a fourth OFDM symbol of each slot of the normal CP is used in the transmission of a demodulation reference signal (DM RS) for the PUSCH.

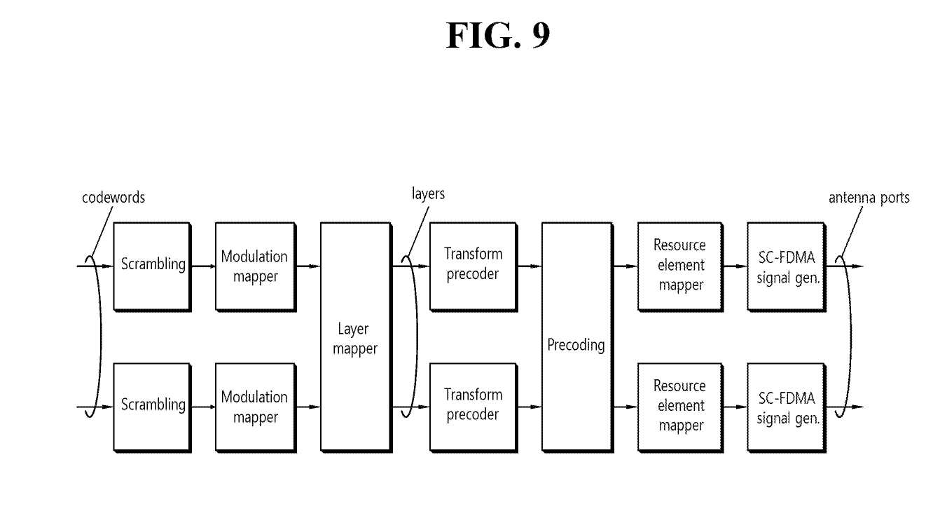

FIG. 9 illustrates a procedure of signal processing for transmitting PUCCH/PUSCH in LTE.

Referring to FIG. 9, coded data is generated by encoding data that construct a transport block according to a predetermined coding scheme. The coded data is referred to a codeword, and the codeword d may be represented by the following equation.

b^{(q)}(0), . . . ,b^{(q)}(M_{bit}^{(q)}−1) [Equation 1]

Here, q is an index of codeword, and M^{(q)}_{bit} is a bit number of q codeword.

The codeword is performed by scrambling. When scrambled bits are referred to \tilde{b}^{(q)}(0), . . . , \tilde{b}^{(q)}(M_{bit}^{(q)}−1), the scrambled bits may be represented as follows.

\tilde{b}^{(q)}(i)=(b^{(q)}(i)+c^{(q)}(i))mod 2 [Equation 2]

In the above equation, c^{(q)}(i) is a scrambling sequence.

The scrambled codeword is modulated to a symbol that represents a location on signal constellation by a modulation mapper. There is no limit in modulation scheme, and m-Phase Shift Keying (m-PSK) or m-Quadrature Amplitude Modulation (m-QAM) may be used. For example, the m-PSK may be BPSK, QPSK or 8-PSK. The m-QAM may be 16-QAM or 64-QAM.

The modulated codeword is mapped to an appropriate resource element by a resource element mapper going through layer mapping, transform precoding by a transform precoder and precoding. Then, the codeword is generated into SC-FDMA signals by an SC-FDMA signal generator, and then transmitted through an antenna.

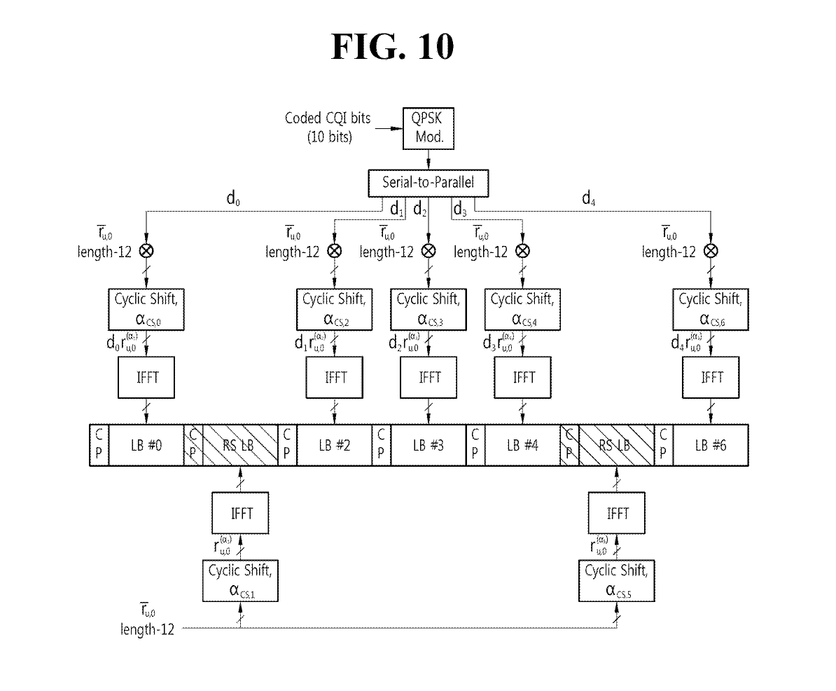

FIG. 10 illustrates a channel structure of a PUCCH format 2/2a/2b for one slot in a normal CP.

As described above, the PUCCH format 2/2a/2b is used to transmit the CQI.

Referring to FIG. 10, SC-FDMA symbols 1 and 5 are used for a demodulation reference symbol (DM RS) which is an uplink reference signal in the normal CP. In the extended CP, an SC-FDMA symbol 3 is used for the DM RS.

10 CQI information bits are channel-coded at for example, ½ rate to become 20 coded bits. In the channel coding, a Reed-Muller (RM) code may be used. In addition, the information bits are scrambled (similarly as PUSCH data being scrambled with a gold sequence having a length of 31) and thereafter, mapped with QPSK constellation, and as a result, a QPSK modulation symbol is generated (d₀ to d₄ in slot 0). Each QPSK modulation symbol is modulated by a cyclic shift of a basic RS sequence having a length of 12 and OFDM-modulated and thereafter, transmitted in each of 10 SC-FDMA symbols in the subframe. Twelve periodic shifts uniformly separated allow twelve different user equipments to be orthogonally multiplexed in the same PUCCH resource block. As a DM RS sequence applied to the SC-FDMA symbols 1 and 5, the basic RS sequence having the length of 12 may be used.

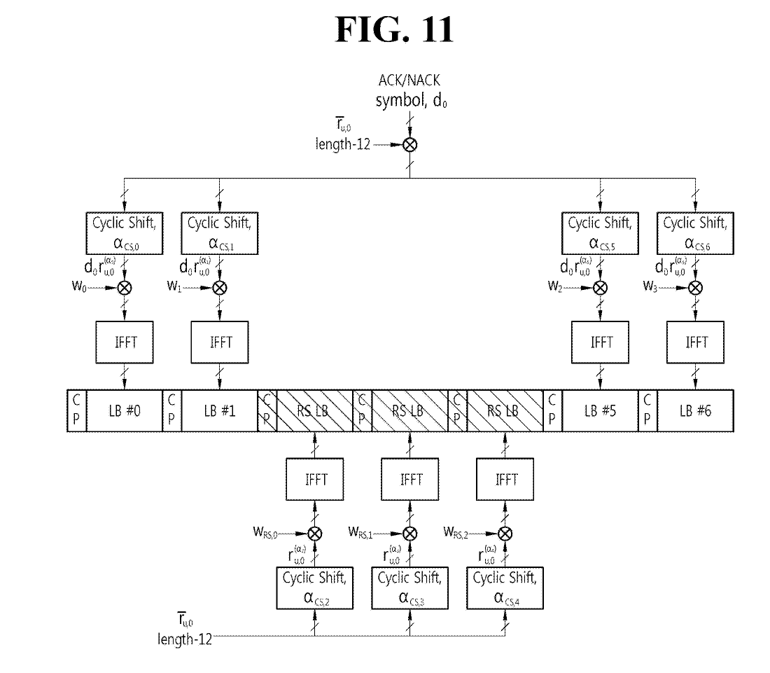

FIG. 11 illustrates a PUCCH format 1a/1b for one slot in the normal CP.

The uplink reference signal is transmitted from third to fifth SC-FDMA symbols. In FIG. 11, w₀, w₁, w₂, and w₃ may be modulated in the time domain after inverse fast Fourier transform (IFFT) modulation or modulated in the frequency domain before the IFFT modulation.

In the LTE, the ACK/NACK and the CQI may be simultaneously transmitted in the same subframe and may not be permitted to be simultaneously transmitted. At the time, the ACK/NACK is an ACK/NACK for a single cell. When the ACK/NACK and the CQI are not permitted to be simultaneously transmitted, the UE may need to transmit the ACK/NACK in a PUCCH of a subframe in which CQI feedback is configured. In this case, the CQI is dropped, and only the ACK/NACK is transmitted through the PUCCH format 1a/1b.

Simultaneous transmission of the ACK/NACK and the CQI in the same subframe can be achieved through UE-specific higher layer signaling. When simultaneous transmission is available, 1-bit or 2-bit ACK/NACK information needs to be multiplexed to the same PUCCH RB in a subframe in which a BS scheduler permits simultaneous transmission of the CQI and the ACK/NACK. In this case, it is necessary to preserve a single-carrier property having a low cubic metric (CM). A method of multiplexing the CQI and the ACK/NACK while preserving the single-carrier property is different between a normal CP case and an extended CP case.

First, when 1-bit or 2-bit ACK/NACK and CQI are transmitted together by using the PUCCH formats 2a/2b in the normal CP case, ACK/NACK bits are not scrambled, and are subjected to BPSK (in case of 1 bit)/QPSK (in case of 2 bits) modulation to generate a single HARQ ACK/NACK modulation symbol d_{HARQ}. The ACK is encoded as a binary ‘1’ and the NACK is encoded as a binary ‘0’. The single HARQ ACK/NACK modulation symbol d_{HARQ} is used to modulate a second RS symbol in each slot. That is, the ACK/NACK is signaled by using an RS.

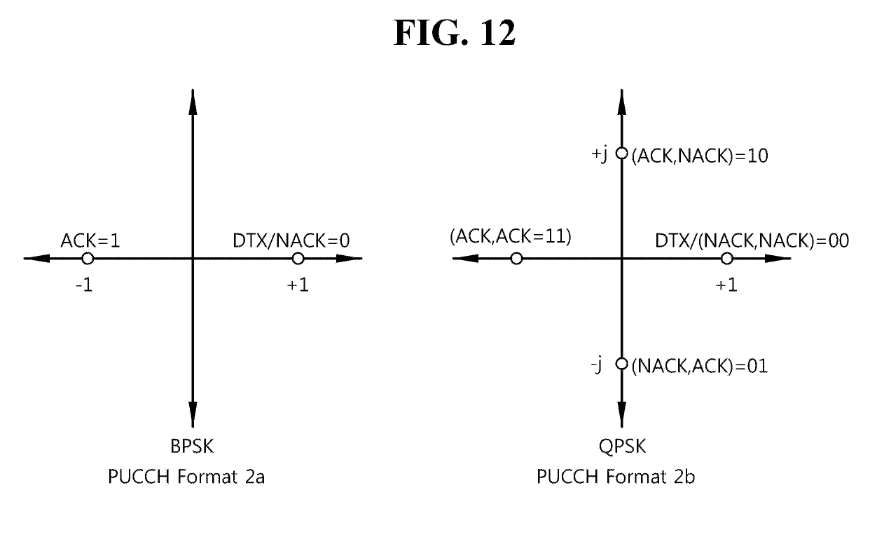

FIG. 12 illustrates an example of constellation mapping of ACK/NACK in a normal CP.

Referring to FIG. 12, NACK (or NACK/NACK in case of transmission of two DL codewords) is mapped to +1. In discontinuous transmission (DTX) which implies a case where a UE fails to detect a DL grant, neither ACK nor NACK is transmitted, and a default NACK is set in this case. The DTX is interpreted as NACK by a BS, and causes DL retransmission.

Next, 1- or 2-bit ACK/NACK is joint-coded with CQI in an extended CP case in which one RS symbol is used per slot.

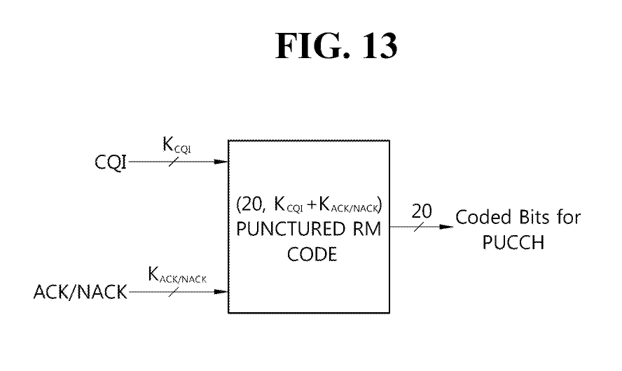

FIG. 13 illustrates an example of joint coding between ACK/NACK and CQI in an extended CP.

Referring to FIG. 13, a maximum number of bits of an information bit supported by a block code may be 13. In this case, a CQI information bit K_{eqi}, may be 11 bits, and an ACK/NACK information bit K_{ACK/NACK} may be 2 bits. The CQI information bit and the ACK/NACK information bit are joint-coded, and become block codes of 20 bits based on Reed-Muller. The 20-bit codeword generated in this process is transmitted through a PUCCH having the channel structure described above.

The table below is an example of (20, A) RM code used in channel coding of Uplink Control Information (UCI) in 3GPP LTE. Here, ‘A’ may be a bit number (i.e., K_{cqi}+K_{ACK/NACK}) of a bit stream to which the CQI information bit and the ACK/NACK information bit are connected. When the bit stream is a₀, a₁, a₂, . . . , a_{A-1}, the bit stream may be used as an input of a channel coding block using the (20, A) RM code.

TABLE 8

| i | M_{i, 0} | M_{i, 1} | M_{i, 2} | M_{i, 3} | M_{i, 4} | M_{i, 5} | M_{i, 6} | M_{i, 7} | M_{i, 8} | M_{i, 9} | M_{i, 10} | M_{i, 11} | M_{i, 12} |
|---|---|---|---|---|---|---|---|---|---|---|---|---|---|
| 0 | 1 | 1 | 0 | 0 | 0 | 0 | 0 | 0 | 0 | 0 | 1 | 1 | 0 |
| 1 | 1 | 1 | 1 | 0 | 0 | 0 | 0 | 0 | 0 | 1 | 1 | 1 | 0 |
| 2 | 1 | 0 | 0 | 1 | 0 | 0 | 1 | 0 | 1 | 1 | 1 | 1 | 1 |
| 3 | 1 | 0 | 1 | 1 | 0 | 0 | 0 | 0 | 1 | 0 | 1 | 1 | 1 |
| 4 | 1 | 1 | 1 | 1 | 0 | 0 | 0 | 1 | 0 | 0 | 1 | 1 | 1 |
| 5 | 1 | 1 | 0 | 0 | 1 | 0 | 1 | 1 | 1 | 0 | 1 | 1 | 1 |
| 6 | 1 | 0 | 1 | 0 | 1 | 0 | 1 | 0 | 1 | 1 | 1 | 1 | 1 |
| 7 | 1 | 0 | 0 | 1 | 1 | 0 | 0 | 1 | 1 | 0 | 1 | 1 | 1 |
| 8 | 1 | 1 | 0 | 1 | 1 | 0 | 0 | 1 | 0 | 1 | 1 | 1 | 1 |
| 9 | 1 | 0 | 1 | 1 | 1 | 0 | 1 | 0 | 0 | 1 | 1 | 1 | 1 |
| 10 | 1 | 0 | 1 | 0 | 0 | 1 | 1 | 1 | 0 | 1 | 1 | 1 | 1 |
| 11 | 1 | 1 | 1 | 0 | 0 | 1 | 1 | 0 | 1 | 0 | 1 | 1 | 1 |
| 12 | 1 | 0 | 0 | 1 | 0 | 1 | 0 | 1 | 1 | 1 | 1 | 1 | 1 |
| 13 | 1 | 1 | 0 | 1 | 0 | 1 | 0 | 1 | 0 | 1 | 1 | 1 | 1 |
| 14 | 1 | 0 | 0 | 0 | 1 | 1 | 0 | 1 | 0 | 0 | 1 | 0 | 1 |
| 15 | 1 | 1 | 0 | 0 | 1 | 1 | 1 | 1 | 0 | 1 | 1 | 0 | 1 |
| 16 | 1 | 1 | 1 | 0 | 1 | 1 | 1 | 0 | 0 | 1 | 0 | 1 | 1 |
| 17 | 1 | 0 | 0 | 1 | 1 | 1 | 0 | 0 | 1 | 0 | 0 | 1 | 1 |
| 18 | 1 | 1 | 0 | 1 | 1 | 1 | 1 | 1 | 0 | 0 | 0 | 0 | 0 |
| 19 | 1 | 0 | 0 | 0 | 0 | 1 | 1 | 0 | 0 | 0 | 0 | 0 | 0 |

Bits b₀, b₁, b₂, B_{B-1} which are channel-coded by an RM code can be generated by Equation 3 below.

$${b}_{i} = {\sum }_{n = 0}^{A - 1} ( {a}_{n} \cdot {M}_{i , n} ) mod 2 \qquad [ Equation 3 ]$$

In Equation 3 above, i=0, 1, 2, . . . , B−1.

In LTE, ACK/NACK and SR may be multiplexed.

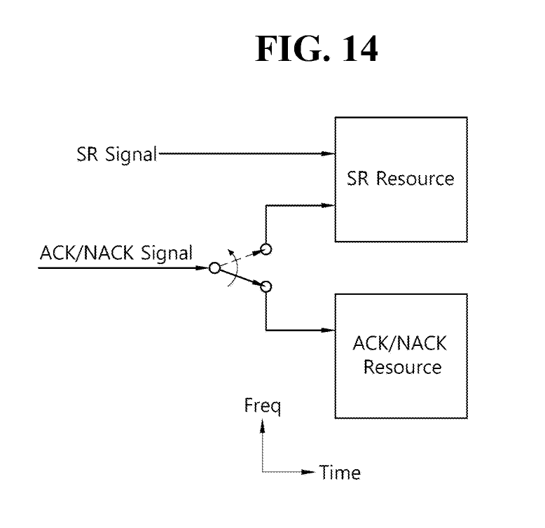

FIG. 14 illustrates a method of multiplexing ACK/NACK and SR.

Referring to FIG. 14, when ACK/NACK and SR are transmitted simultaneously in the same subframe, a UE transmits the ACK/NACK by using an allocated SR resource. In this case, the SR implies positive SR. In addition, the UE may transmit ACK/NACK by using an allocated ACK/NACK resource. In this case, the SR implies negative SR. That is, according to which resource is used to transmit ACK/NACK in a subframe in which the ACK/NACK and the SR are simultaneously transmitted, a BS can identify not only the ACK/NACK but also whether the SR is positive SR or negative SR.

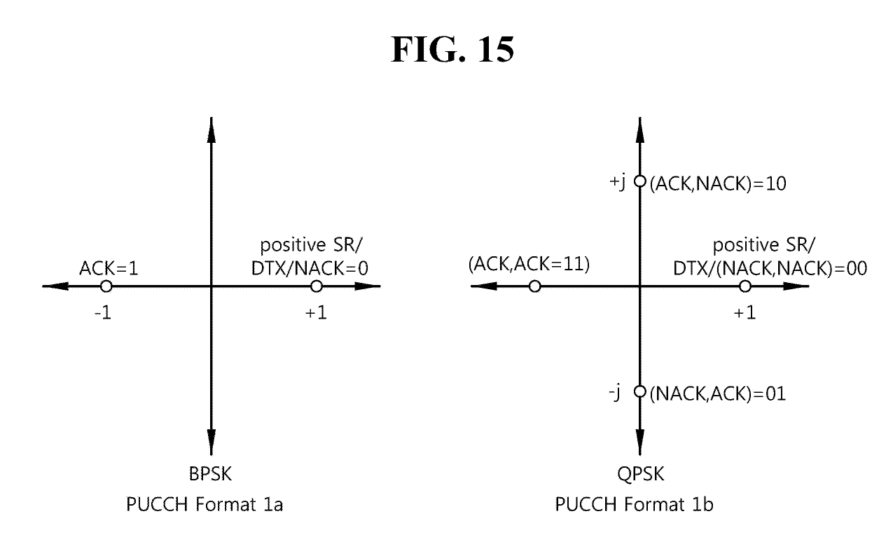

FIG. 15 illustrates constellation mapping when ACK/NACK and SR are simultaneously transmitted.

Referring to FIG. 15, DTX/NACK and positive SR are mapped to +1 of a constellation map, and ACK is mapped to −1.

Meanwhile, a wireless communication system may support a carrier aggregation system. Here, the carrier aggregation means constructing a broad band by aggregating a plurality of carriers having small bandwidth. The carrier aggregation system means a system that construct a broad band by aggregating one or more carriers having smaller bandwidth than a broadband which is targeted, which the wireless communication system is to support.

In the LTE TDD system, a UE may feed back multiple ACK/NACK for multiple PDSCHs to a BS. This is because the UE may receive the multiple PDSCHs in multiple subframes, and may transmit ACK/NACK for the multiple PDSCHs in one subframe. In this case, there are two types of ACK/NACK transmission methods as follows.

The first method is ACK/NACK bundling. The ACK/NACK bundling is a process of combining ACK/NACK bits for multiple data units by using a logical AND operation. For example, if the UE decodes all the multiple data units successfully, the UE transmits only one ACK bit. Otherwise, if the UE fails in decoding (or detecting) any one of the multiple data units, the UE may transmit NACK bit or may transmit no signal.

The second method is ACK/NACK multiplexing. In the ACK/NACK multiplexing, the content and meaning of the ACK/NACK for the multiple data units may be identified by combining a PUCCH resource used in actual ACK/NACK transmission and one of QPSK modulation symbols.

For example, it is assumed that up to two data units may be transmitted, and one PUCCH resource may carry two bits. It is also assumed that an HARQ operation for each data unit can be managed by one ACK/NACK bit. In this case, the ACK/NACK may be identified at a transmitting node (e.g., a BS) which transmits the data unit according to Table 9 below.

TABLE 9

| HARQ-ACK(0), HARQ-ACK(1) | n⁽¹⁾_{PUCCH} | b(0), b(1) |
|---|---|---|
| ACK, ACK | n⁽¹⁾_{PUCCH, 1} | 1, 1 |
| ACK, NACK/DTX | n⁽¹⁾_{PUCCH, 0} | 0, 1 |
| NACK/DTX, ACK | n⁽¹⁾_{PUCCH, 1} | 0, 0 |
| NACK/DTX, NACK | n⁽¹⁾_{PUCCH, 1} | 1, 0 |
| NACK, DTX | n⁽¹⁾_{PUCCH, 0} | 1, 0 |

| | |
|---|---|
| DTX, DTX | N/A |

In Table 9 above, HARQ-ACK(i) indicates an ACK/NACK result for a data unit i. In the above example, two data units may exist, i.e., a data unit 0 and a data unit 1. In Table 9, DTX implies that there is no data unit transmission for the HARQ-ACK(i). Alternatively, it implies that a receiving end (e.g., a UE) fails to detect the data unit for the HARQ-ACK(i). n⁽¹⁾_{PUCCH,X} indicates a PUCCH resource used in actual ACK/NACK transmission. There are up to 2 PUCCH resources, that is, n⁽¹⁾_{PUCCH,0} and n⁽¹⁾_{PUCCH,1}. b(0) and b(1) denote 2 bits delivered by a selected PUCCH resource. A modulation symbol transmitted using the PUCCH resource is determined by b(0) and b(1).

For example, if the receiving end successfully receives two data units and decodes the received data units, the receiving end has to transmit two bits b(0) and b(1) in a form of (1, 1) by using a PUCCH resource n⁽¹⁾_{PUCCH,1.} For another example, it is assumed that the receiving end receives two data units, and in this case, the receiving end fails to decode a first data unit and successfully decodes a second data unit. Then, the receiving end has to transmit (0, 0) by using n⁽¹⁾_{PUCCH,1}.

As such, according to a method in which the content (or meaning) of ACK/NACK is linked to a combination of a PUCCH resource and the content of an actual bit transmitted using the PUCCH resource, ACK/NACK transmission for the multiple data units is available by using a single PUCCH resource.

In the ACK/NACK multiplexing method, if at least one ACK exists for all data units, NACK and DTX are basically coupled as NACK/DTX. This is because a combination of a PUCCH resource and a QPSK symbol is not enough to cover all ACK/NACK combinations based on decoupling of the NACK and the DTX.

<A Next Generation Communication System>

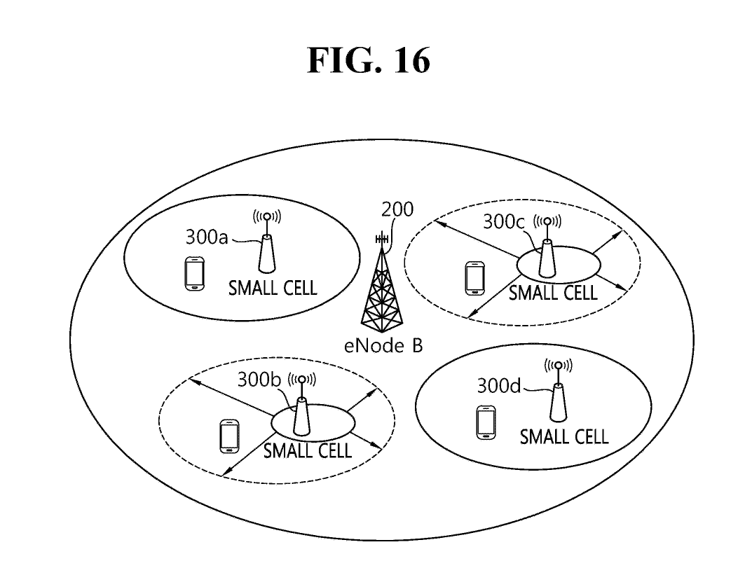

Meanwhile, in a next generation mobile communication system, it is anticipated that a small cell of which cell coverage radius is small is added in coverage of the existing cell, and it is also anticipated that the small cell processes more traffic. Since the existing cell has larger coverage than the small cell, the existing cell may also be referred to a macro cell. Hereinafter, this will be described by reference to FIG. 16.

FIG. 16 is a diagram illustrating a hetero network environment in which a macro cell and a small cell are mixed, which has a possibility of becoming a next generation wireless communication system.

Referring to FIG. 16, a hetero network environment is shown. In the environment, a macro cell according to the existing BS 200 is overlapped by a small cell according to one or more small BSs 300a, 300b, 300c and 300d. Since the existing BS provides larger coverage than the small BS, the existing BS is referred to a macro BS (macro eNodeB, MeNB). In this specification, the terms, macro cell and macro BS will be used with being mixed. A UE accessed to the macro cell 200 may be referred to a macro UE. The macro UE receives DL signals from the macro BS and transmits UL signals to the macro BS.

In such a hetero network, by configuring the macro cell as a primary cell (Pcell) and configuring the small cell as a secondary cell (Scell), coverage gaps in the macro cell may be filled. In addition, by configuring the small cell as a primary cell (Pcell) and configuring the macro cell as a secondary cell (Scell), overall performance may be boosted.

Meanwhile, the small cell may use the frequency band assigned to LTE/LTE-A currently, or may use higher frequency band (e.g., band over 3.5 GHz) than LTE/LTE-A.

On the other hand, in a next LTE-A system, it has been considered that the small cell cannot be used independently, but used only for a macro-assisted small cell that can be used with the support of macro cell.

Since the small cells 300a, 300b, 300c and 300d may have similar channel environments with each other and are located neighboring distances with each other, the interference between small cells may be a big problem.

In order to reduce the influences on the interference, the small cells 300b and 300c may extend or reduce their coverage. As such, the extension and reduction of coverage is referred to cell breathing. For example, as shown in the drawing, the small cells 300b and 300c may be on or off depending on the situation.

Meanwhile, the small cell may use the frequency band assigned to LTE/LTE-A currently, or may use higher frequency band (e.g., band over 3.5 GHz) than LTE/LTE-A.

As described above, in a next generation communication system, the small cell may be used, and accordingly, the channel environment that a UE experiences may be better than previous environment. In such a case, instead of the existing modulation scheme (e.g., BPSK, QPSK, 16 QAM and 64 QAM), a high order modulation scheme such as 256 QAM may be introduced.

However, in the existing 3GPP LTE/LTE-A system, all of the CSI report, the MCS configuration, and the like are designed in accordance with maximum 64 QAM. Here, the CSI report includes a UCI transmission using PUCCH format 2, and the MCS configuration includes DCI information on a PDSCH.

Accordingly, in order to introduce a new modulation scheme such as 256 QAM in a next generation communication system, it is required to improve procedures in relation to the MCS configuration or the CSI report.

For this reason, a disclosure of the present specification proposes a way to improve the CSI report procedure in case of newly introducing high order modulation such as 256 QAM.

Particularly, as shown in Table 2, in the existing LTE-A system, total 16 states of CQI is designated to QPSK, 16 QAM and 64 QAM, and which are expressed by 4 bits. In a next generation system, for introducing 256 QAM, a method of using the existing CQI table shown in Table 2 and a new table including 256 QAM may be considered, or a bit number of the CQI information may be increased by extending the size of CQI table so as to include 256 QAM. Here, in case of using two tables, for the convenience of description, it is assumed that the information on the CQI itself is maintained in 4 bits, and the additional information (e.g., 1 bit) on a configuration selected by any one of the two tables is added. On the contrary, in case of extending the CQI table, it is assumed that the information on the CQI is extended to 5 bits. In addition, hereinafter, it is assumed that the CSI report using a PUCCH is performed through PUCCH format 2. Although the case of extending CQI types by 256 QAM is described in the embodiment of the present invention, not limited to a modulation order, but the case of adding or extending CQI types may also be applied.

I. CSI Report Through a PUCCH

The CSI report may include a combination of RI, broad band CQI, sub band CQI, PMI, and so on, and may support up to maximum 11 bits. According to increase of bit number (information designating the CQI itself and/or information on use table) for the CQI together with introducing 256 QAM, the support in the existing scheme may be impossible. In this case, a transmission technique for additional bits may be required. More detailed three methods will be described below.

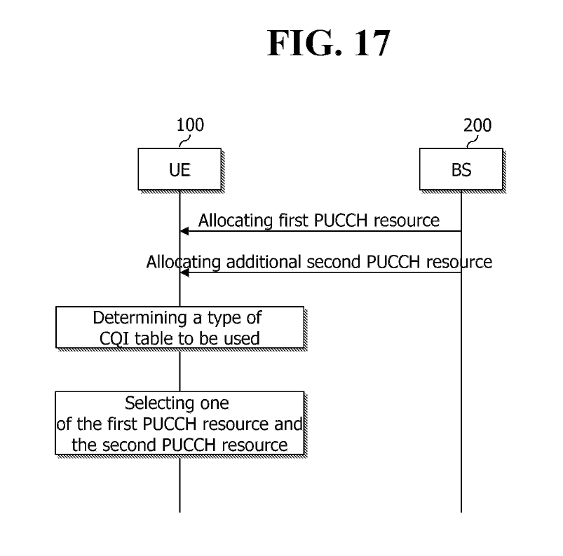

As a first method, for the UEs that supports 256 QAM, a BS allocates PUCCH resources to each UE additionally. In particular, this will be described by reference to FIG. 17 as below.

FIG. 17 is an exemplary diagram illustrating a method according to a disclosure.

As we can know by reference to FIG. 17, a BS 200 may allocate a first PUCCH resource and an additional second PUCCH resource to a UE 100. Here, the UE 100 may be a UE that uses PUCCH format 2. And the UE 100 may be a UE that may support 256 QAM, or a UE configured by a higher layer. In addition, the BS 200 itself may be configured to determine a type of CQI table that the UE 100 is to use. The configuration may be delivered through a higher layer signal, for example, an RRC signal. At the moment, in case that the UE 100 supports 256 QAM but the first and second PUCCH resources are allocated to the UE 100 in a state of not receiving higher layer signal, the corresponding UE may assume that the BS 100 is available to support 256 QAM.

Meanwhile, then, the UE 100 determines a type of CQI table to use. The type of CQI table may be distinguished by a first CQI table that does not include 256 Quadrature Amplitude Modulation (QAM) and a second CQI table that includes 256 QAM.

Subsequently, the UE 100 may select either one of the first PUCCH resource or the second PUCCH resource based on the selected CQI table.

For example, in case that the UE 100 uses a first table, the UE may determine to transmit the CSI by using the first PUCCH resource, for example, n_{PUCCH}⁽²⁾, and in case that the UE 100 uses a second table, the UE may determine to transmit the CSI by using the second PUCCH resource, for example, n_{PUCCH,2}⁽²⁾. In the above description, the first table may be the CQI table shown in Table 2, and the second table may be the CQI table including 256 QAM.

Meanwhile, the BS 200 may detect whether the CQI information corresponds to the first table or the second table through the PUCCH resource that the UE uses in transmission by using DTX detection and the like. This method may also be applied to the case that a number of states of CQI table are increased. At the moment, the number of increased states may be 32.

On the other hand, the subframe to which the PUCCH resource is allocated may be a subframe that corresponds to a CSI report type including the CQI. More particularly, such a subframe may be a subframe on which the periodic CSI report is transmitted using PUCCH format 2. Otherwise, the subframe may be a subframe on which a UE transmits the periodic CSI report in case that RI is greater than 1. If RI is 1, a UE may transmit the CQI of 5 bits (based on the RI that performs the previous report). In such a case, in the CQI table shown in Table 2, 0 may be used for expressing the last bit of the 5 bits, and 1 in the CQI table including 256 QAM may be used for expressing the last bit of the 5 bits. Such a method may be applied to the CSI report in which the CQI is included but the PMI is not included. Otherwise, such a method may also be applied to the CSI report in which the PMI and the RI are not included. In case that additional bit number is more increased by introducing 256 QAM, such as the case that a type of table is diversified or a table size which is increased so as to include 256 QAM becomes greater than that of corresponding to 5 bits, an additional PUCCH resource allocation may be considered.

As a second method, an additional bit which is added in the CQI by introducing 256 QAM may be transmitted through a region that corresponds to HARQ-ACK in PUCCH format 2/2a/2b. In case of the PUCCH format 2, in order to simultaneously transmit the HARQ-ACK and the CSI in the extended CP, information of maximum 13 bits may be transmitted through joint coding, and in case of the normal CP, additional 2 bits may be transmitted through RS modulation. More detailed examples for the second method are as follows.

As a first example of the second method, regardless of the normal CP and the extended CP, the CSI information that includes additional bits added by 256 QAM may be transmitted by joint coding. The CSI report in which the differential CQI and the PMI are simultaneously included may be transmitted without any problems even though the CQI table is extended from the existing 4 bits to 5 bits, since the CSI report is available up to maximum 13 bits.

As a second example of the second method, in case of the normal CP, it may be considered that a UE transmits information on two CQI tables in the RS modulation scheme. Particularly, in each slot, any one RS between two RSs may be multiplied by a symbol that corresponds to information on the configuration of the CQI table. In case of the extended CP, it may be considered to take the joint coding scheme according to the first example of the second method described above.

Meanwhile, in case of the extended CP, 256 QAM may not be supported. This is because there is little possibility of the extended CP being applied since the small cell in which 256 QAM is used has good channel environment.

The subframe to which the second example of the second method is applied may be a subframe that corresponds to a CSI report type that includes the CQI. More particularly, such a subframe may be a subframe on which the periodic CSI report is transmitted using PUCCH format 2. In addition, more particularly, the subframe may be a subframe on which a UE transmits the periodic CSI report in case that RI is greater than 1. If RI is 1, a UE may transmit the CQI of 5 bits (based on the RI that performs the previous report). In such a case, in the CQI table shown in Table 2, 0 may be used for expressing the last bit of the 5 bits, and 1 in the CQI table including 256 QAM may be used for expressing the last bit of the 5 bits. Such a method may be applied to the CSI report in which the CQI is included but the PMI is not included. Otherwise, such a method may also be applied to the CSI report in which the PMI and the RI are not included.

As a third method, an introduction of a new CSI report mode may be considered. Particularly, a CSI report type may be added to the PUCCH report mode, and the type includes an additional bit according to 256 QAM. As an example of more particular transmission, the additional bit according to 256 QAM is allocated to the CSI report type, and the corresponding report type is transmitted through a PUCCH resource which is different from the existing CSI (e.g., RI, CQI/PMI, etc.). In the above description, the PUCCH resource may be CSI subframes different with each other.

2. A Solution when HARQ-ACK and CSI Collide

In case that HARQ-ACK and CSI are transmitted in an identical subframe, the CSI might be dropped or simultaneously transmitted through an identical resource according to whether the HARQ-ACK and the CSI that are configured by a higher layer are simultaneously transmitted. In case that the simultaneous transmission is configured in the conventional 3GPP LTE-A system, the HARQ-ACK and the CSI might be simultaneously transmitted by PUCCH format 2a/2b in the normal CP, and by PUCCH format 2 in the extended CP.

Accordingly, in case that the CSI report procedure is changed by adding CQI types due to introducing 256 QAM as described above, there may also be a change in a procedure to solve the situation in which the HARQ-ACK and the CSI collide in the same subframe. The followings are detailed examples of each method in case that the HARQ-ACK and the CSI are configured to be simultaneously transmitted.

According to the first method, in case that the HARQ-ACK and the CSI collide in the same subframe in a situation that a plurality of PUCCH resources are allocated to a UE, on the PUCCH resource which is selected according to table selection, the HARQ-ACK and the CSI may be transmitted using PUCCH format 2a/2b in case of the normal CP, and transmitted using PUCCH format 2 in case of the extended CP.

According to the second method, in case that the CSI information that include an additional bit according to introducing 256 QAM is transmitted up to maximum 13 bits in the joint coding scheme, the HARQ-ACK may be simultaneously transmitted through the RS modulation similar to the shape of PUCCH format 2a/2b in case of the normal CP. That is, it may be considered that the extended CSI information is transmitted through the RM coding, and the HARQ-ACK is transmitted through the RS modulation. At the moment, in case of the extended CP, or in case of mapping the additional bit according to introducing 256 QAM to a location that corresponds to the HARQ-ACK, the following exemplary method may be considered. As a first example, when the CSI and the HARQ-ACK collide, the table which is added by introducing 256 QAM is not used. That is, only for the corresponding subframe, the CQI table shown in Table 2 is used. As a second example, when the CSI and the HARQ-ACK collide, the CSI is dropped and the HARQ-ACK is transmitted.

In case that a new CSI report mode is introduced according to a third method, a priority rule may be configured. It may be configured that the CSI report type newly added by introducing 256 QAM may have lower priority that the HARQ-ACK and the RI, and have higher priority than the CQI/PMI.

3. Piggyback CSI on PUSCH

In a subframe on which a PUCCH and a PUSCH are simultaneously transmitted, the periodic CSI may be piggybacked to a PUSCH, and in this case, it may be required to configure an additional bit according to the PUCCH transmission scheme. As described above, in case that a BS allocates PUCCH resources for each UE additionally for the UEs that uses PUCCH format 2 and supports 256 QAM, the information on a PUCCH resource selection is utilized when transmitting the additional bit according to introducing 256 QAM, and when the CSI is piggybacked on a PUSCH, a method for expressing this should be considered. In this case, a flag bit may be added according to a selected table or a PUCCH resource. The followings are more detailed examples.

As a first example, if the first table (the table shown in Table 2) is selected and the CSI is to transmit using a first PUCCH resource, that is, n_{PUCCH}⁽²⁾, 0 is attached behind the LSB of the CSI information. On the other hand, if the second table (i.e., table including 256 QAM) is selected, 1 is attached behind the LSB of the CSI information. The flag bit 0 or 1 means that it is before encoded.

As a second example, additional information on the CQI table selection or the PUCCH resource selection may be separately encoded from CQI/PMI. The additional information may be encoded in the same method with the RI, and mapped to a region in which the RI is mapped together. Such the second example may also be applied to the periodic CSI. At the moment, in case that the additional information and the RI are simultaneously transmitted, after the additional information is added to the LSB of the RI and is encoded, may be mapped to the region in which the RI is mapped together. The number of symbols which are encoded in a PUSCH may be determined by summation of the RI information bit number in the corresponding subframe and the CQI bit number which is added by introducing 256 QAM.

Meanwhile, if it is assumed that the PMI and the RI are configured as ON and a UE may transmit only CQI bit of 4 bits, the UE that supports 256 QAM may select one of the CQI table for 256 QAM or the conventional CQI table shown in Table 2. As a standard for the selection, if RI>1 based on the recently reported RI, 256 QAM table may be selected. And, if RI=1, the conventional table shown in Table 2 may be selected. Otherwise, if RI=1, the CQI of 5 bits may be transmitted.

4. Aperiodic CSI Report Transmission on PUSCH

Similar to the periodic CSI report, in case of the aperiodic CSI report, according to introducing 256 QAM, a new CQI table which is extended by the conventional CQI table shown in Table 2 is used, or a second CQI table that includes 256 QAM in addition to the conventional first CQI table shown in Table 2 may be added and used. The use of the CQI table that includes 256 QAM in the aperiodic CSI report may be either independent from the use of the CQI table that includes 256 QAM in the periodic CSI report or dependent with it. As an example, in case that it is configured to use the second CQI table that includes 256 QAM in the periodic CSI report, the use of the conventional first CQI table that does not include 256 QAM shown in Table 2 may be considered in the aperiodic CSI report, or the opposite case may also be considered. As a ground of the above description, with the object of managing the table selection more flexibly according to whether 256 QAM is used, in a situation that a channel situation is changed depending on UE's movement, the CQI is transmitted according to the CQI table that includes 256 QAM through the periodic CSI report, and the CQI is transmitted according to the conventional CQI table that does not include 256 QAM through the aperiodic CSI report, thereby a BS may efficiently determine the use of 256 QAM and efficiently select the CQI selection synthetically. On the other hand, it may be considered that the periodic CSI report is based on the conventional CQI table shown in Table 2, and the aperiodic CSI report is based on the CQI table that includes 256 QAM.

It may be considered whether the CQI table used for the aperiodic CSI report is the conventional CQI table shown in Table 2 or the CQI table that includes 256 QAM may be notified to a UE through a higher layer signal, or through a UL grant that indicates the aperiodic CSI. Otherwise, a method may also be considered that the information selected by a UE is notified to a BS though a PUSCH that includes the aperiodic CSI. The followings are more detailed examples of the above method.

As a first example, in case that the CQI table that includes 256 QAM is used for the aperiodic CSI report, the PDCCH or the EPDCCH that is to indicate the corresponding CSI report to a UE may include information on the table selection. As a more detailed example, in case that the use of the CQI table that includes 256 QAM is indicated to a UE, a scrambling sequence may be determined based on the information on the CQI table selection in the PDCCH or the EPDCCH that is to transmit the corresponding DCI. As an example, when determining a seed value of the scrambling sequence, whether the use of the CQI table that includes 256 QAM may also be considered. Otherwise, in case of indicating the use of 256 QAM to a UE, in addition to the scrambling sequence, a masking sequence may be XOR operated. Such an example may also be applied when it is notified to a UE whether the CQI table that includes 256 QAM is used through the DCI when requesting the aperiodic CSI request.

As a second example, in case that the CQI table that includes 256 QAM is used for the aperiodic CSI report, the PDCCH or the EPDCCH that is to indicate the corresponding CSI report may include information on the table selection. As a more detailed example, in case that the use of the CQI table that includes 256 QAM is indicated, in the PDCCH or the EPDCCH that is to transmit the corresponding DCI, a masking may be differently applied depending on information of CQI table selection in CRC. As an example, in case of using the CQI table that includes 256 QAM when aperiodic CSI reporting, it may be considered to perform XOR operation [1, 1, 1, 1, 1, 1, 1, 1, 1, 1, 1, 1, 1, 1, 1, 1] on CRC of 16 bits for DCI. The masking sequence is just an example, but introducing other sequence may be considered. Such an example may also be applied when it is notified to a UE whether the CQI table that includes 256 QAM is used through the DCI when requesting the aperiodic CSI request.

As a third example, whether a UE uses the CQI table that includes 256 QAM in the aperiodic CSI report may be notified by additionally CRC masking to the CRC of CQI/PMI in a PUSCH that includes aperiodic CSI. CRC may be added to the CRC of CQI/PMI if the CQI table that includes 256 QAM is used even in case that information bit number of CQI/PMI is less than 11 bits. As a more particular method, the use of the CQI table that includes 256 QAM by a UE may be notified by adding [1, 1, 1, 1, 1, 1, 1, 1] to the CRC of bits for CQI/PMI by XOR operation. Or, the use of the conventional CQI table by a UE may be notified by adding [0, 0, 0, 0, 0, 0, 0, 0] as a masking sequence using XOR operation or by adding CRC itself in case that CRC is existed in CQI/PMI. The masking sequence is just an example, but introducing other sequence may be considered. Here, if the information bit number on CQI/PMI is less than 11, a BS performs blind decoding by assuming there is CRC, and subsequently, performs XOR operation on the masking sequence [1, 1, 1, 1, 1, 1, 1, 1] and then it may be assumed that 256 QAM is used if there is no error in CRC, and it may be assumed that the conventional CQI table is used if an error occurs in CRC.

Meanwhile, in case that the aperiodic CSI report is performed based on the table including 256 QAM, the above-mentioned DCI transmission method and the aperiodic CSI transmission method may be combined. If it is combined as such, an error on which CQI table is used by CQI in the aperiodic CSI report may be minimized. As an example, in case that a BS instructs to a UE to perform the aperiodic CSI using the CQI table that includes 256 QAM through DCI, a CRC masking for 256 QAM table may be performed to CRC of the DCI. Then, when transmitting the aperiodic CSI that includes the CQI based on 256 QAM table on a PUSCH, the UE may notify whether it is the CQI based on 256 QAM to the BS by performing CRC masking on CQI/PMI in the aperiodic CSI.

The embodiments of the present invention described so far may be implemented through various means. For example, the embodiments of the present invention may be implemented by hardware, firmware, software or the combination thereof. Particularly, this will be described by reference to drawing.

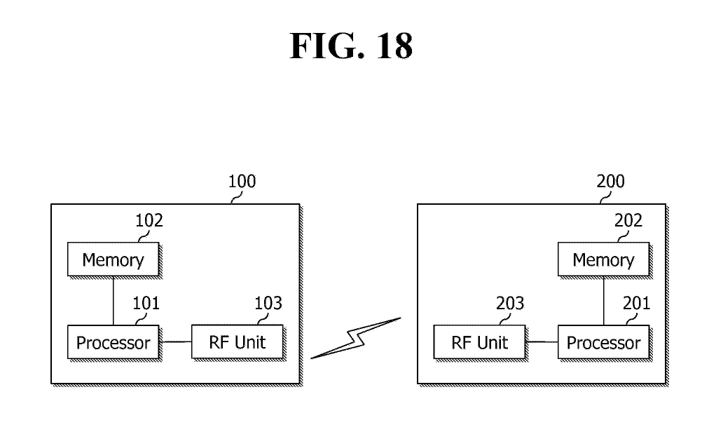

FIG. 18 is a block diagram illustrating a wireless communication system in which a disclosure of the present specification is implemented.

ABS 200 includes a processor 201, a memory 202, and an RF (radio frequency) unit (the MTC device) 203. The memory 202 which is coupled to the processor 201 stores a variety of information for driving the processor 201. The RF unit 203 which is coupled to the processor 201 transmits and/or receives a radio signal. The processor 201 implements the proposed functions, procedure, and/or methods. In the embodiments described above, the operation of BS may be implemented by the processor 201.

A user equipment (UE) 100 includes a processor 101, a memory 102, and an RF (radio frequency) unit 103. The memory 102 which is coupled to the processor 101 stores a variety of information for driving the processor 101. The RF unit 103 which is coupled to the processor 101 transmits and/or receives a radio signal. The processor 101 implements the proposed functions, procedure, and/or methods.

The processor may include Application-Specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

What is claimed is:

1. A method for transmitting a channel quality indicator (CQI) feedback, comprising:
receiving allocation information on a first uplink resource and allocation information on a second uplink resource;
selecting a type of CQI table which is to be used for the CQI feedback, wherein the CQI table includes a first type CQI table that does not includes 256 quadrature amplitude modulation (QAM) and a second type CQI table that includes 256 QAM;
selecting one of the first and second uplink resources according to the selected CQI table; and
transmitting the CQI feedback based on the selected CQI table in the selected uplink resource on an uplink subframe.

2. The method of claim 1, wherein the first uplink resource is used when the CQI feedback is performed based on the first type CQI table that does not include the 256 QAM, and
wherein the second uplink resource is used when the CQI feedback is performed based on the second type CQI table that includes the 256 QAM.

3. The method of claim 1, wherein the CQI feedback is transmitted on a physical uplink control channel (PUCCH).

4. The method of claim 1, wherein the CQI feedback is transmitted using PUCCH format 2a or 2b, if a normal cyclic prefix (CP) is applied to the uplink subframe, and
wherein the CQI feedback is transmitted using PUCCH format 2, if an extended CP is applied to the uplink subframe.

5. The method of claim 1, wherein the second type CQI table further includes a field according to 256 QAM in addition to a field according to the first type CQI table.

6. The method of claim 1, wherein the CQI feedback based on the second type CQI table includes a CQI table of 4-bit length, and 1 bit that divides the second type CQI table.

7. A user equipment for transmitting a channel quality indicator (CQI) feedback, comprising:
a receiving unit configured to receive allocation information on a first uplink resource and allocation information on a second uplink resource;
a processor configured to select a type of CQI table which is to be used for the CQI feedback, and select one of the first and second uplink resources according to the selected CQI table, wherein the CQI table includes a first type CQI table that does not includes 256 quadrature amplitude modulation (QAM) and a second type CQI table that includes 256 QAM; and
a transmitting unit configured to transmit the CQI feedback based on the selected CQI table in the selected uplink resource on an uplink subframe.

8. The user equipment of claim 7, wherein the first uplink resource is used when the CQI feedback is performed based on the first type CQI table that does not include the 256 QAM, and
wherein the second uplink resource is used when the CQI feedback is performed based on the second type CQI table that includes the 256 QAM.

9. The user equipment of claim 7, wherein the CQI feedback is transmitted on a physical uplink control channel (PUCCH).

10. The user equipment of claim 7, wherein the CQI feedback is transmitted using PUCCH format 2a or 2b, if a normal cyclic prefix (CP) is applied to the uplink subframe, and
wherein the CQI feedback is transmitted using PUCCH format 2, if an extended CP is applied to the uplink subframe.

11. The user equipment of claim 7, wherein the second type CQI table further includes a field according to 256 QAM in addition to a field according to the first type CQI table.

12. The user equipment of claim 7, wherein the CQI feedback based on the second type CQI table includes a CQI table of 4-bit length, and 1 bit that divides the second type CQI table.
